(19) United States
(12) Patent Application Publication
(10) Pub. No.: US 2008/0007431 A1
(43) Pub. Date: Jan. 10, 2008

(54) REMOTE MONITORING SYSTEM

(75) Inventor: DAVID JACQUES, Edgecomb, ME (US)

Correspondence Address: BOHAN, MATHERS & ASSOCIATES, LLC, PO BOX 17707, PORTLAND, ME, 04112-8707, US

(73) Assignee: Boatsense Solutions, Inc., Edgecomb, ME (US)

(21) Appl. No.: 11/774,894

(22) Filed: Jul. 9, 2007

Related U.S. Application Data
(63) Continuation of application No. 60/819,176, filed on Jul. 7, 2006.

(51) Int. Cl. G08B 19/00

(52) U.S. Cl. 340/984; 340/540

(57) ABSTRACT

Remote monitoring system for alerting a user of an alarm or a return-to-normal situation. The remote monitoring system has a wireless transceiver for receiving and transmitting text messages via a wireless network to a particular wireless device, such as a cellular or satellite telephone. Coupled to the transceiver is at least one event sensor that monitors a particular parameter, such as water level, battery charge level, temperature, etc. The transceiver is programmed to send an alert text message to a wireless communication device should the event sensor send a signal that triggers the remote monitoring system. Once triggered, the remote monitoring system continues to send messages to the wireless communication device, until it receives confirmation that the message was received. Should the event sensor send a signal that indicates a return to a normal condition, the remote monitoring system sends a return-to-normal message.

### BACKGROUND INFORMATION

1. Field of the Invention

The invention relates to the field of remote monitoring systems.

2. Description of the Prior Art

Remote monitoring systems are necessary in many fields of industry. In the field of marine vessels, for example, boats are typically tied up at dock or at a mooring for extended periods of time, without a person nearby to monitor the proper functioning of the maintenance systems on the boat. It is of critical importance that the boat owner, the operator, or the person charged with maintaining the condition of the vessel be alerted to potentially disastrous situations, such as rising water level in the boat, due to bilge pump failure or a low battery charge, or severe listing of the boat, etc.

What is needed is a remote monitoring system that alerts the system user, who is at a location remote from the equipment or apparatus being monitored, to the occurrence of a certain event. What is further needed is such a system that allows the system user to change the parameters of the system, from a remote location.

### BRIEF SUMMARY OF THE INVENTION

The present invention is a remote monitoring system for and a method of communicating the occurrence of a certain event via wireless technology to the system user. The system comprises at least one event sensor, a wireless transceiver and antenna, an integrated circuit board, and a power supply. The circuit board interfaces between the event sensor, the power supply, and the wireless transceiver. The system user communicates with the remote monitoring system via a wireless device. The term “wireless device” includes any wireless communication device, such as a cellular phone, satellite phone, pager, radio, or other suitable communication devices.

When the event sensor sends a signal that functions as a trigger, the wireless transceiver, also referred to as a “communicator”, automatically sends a corresponding, pre-programmed text message, an “alert message”, to a pre-defined telephone number of a wireless device of a system user. The communicator continues to send the text message until it receives confirmation that the message has been received. If the condition that triggered the communicator to send the alert message returns to normal, the communicator transmits a “return to normal” text message to the same wireless device. Upon query, the communicator automatically transmits a text message, for example, “systems normal”, to confirm that the remote monitoring system is operational.

The system user may access the communicator remotely via the wireless device, for the purpose of confirming the operational status of the system or to re-program the system. Re-programming includes, for example, changing the access code, a telephone number, and/or email address of the wireless device that is to receive system alerts, or changing the parameters in the remote monitoring system that will initiate alert or “return to normal” messages.

Example of an application of the remote monitoring system according to the invention: A water-level sensor is installed in the bilge of a boat, with the sensor output connected to the integrated circuit board in the communicator. When the water level in the bilge reaches a level that indicates that the bilge pump is either not functioning properly or cannot keep up with the amount of incoming water, the sensor sends a signal to the communicator, which then sends a text message, such as, for example, “water level rising,” via a wireless network to the wireless device of the system user, thereby alerting the system user of a potentially disastrous situation on the boat. The communicator continues to send the message until the system user acknowledges receipt of the message. Should the water level drop back to an acceptable level, the communicator sends a second text message, this time a “return to normal” message.

The method of communicating the occurrence of an event to a system user may include a subscription service to a wireless network. The subscription service enables the system to communicate with the Internet via the wireless network, thereby enabling communication between the system and any other device that has access to the Internet, e.g., cell phone, PDA, pager, or computer.

### BRIEF DESCRIPTION OF THE DRAWINGS

The present invention is described with reference to the accompanying drawings. In the drawings, like reference numbers indicate identical or functionally similar elements.

FIG. 1 is a schematic illustration of the remote monitoring system according to the invention.

### DETAILED DESCRIPTION OF THE INVENTION

The present invention will now be described more fully in detail with reference to the accompanying drawings, in which the preferred embodiment of the invention are shown. This invention should not, however, be construed as limited to the embodiments set forth herein; rather, they are provided so that this disclosure will be complete and will fully convey the scope of the invention to those skilled in the art.

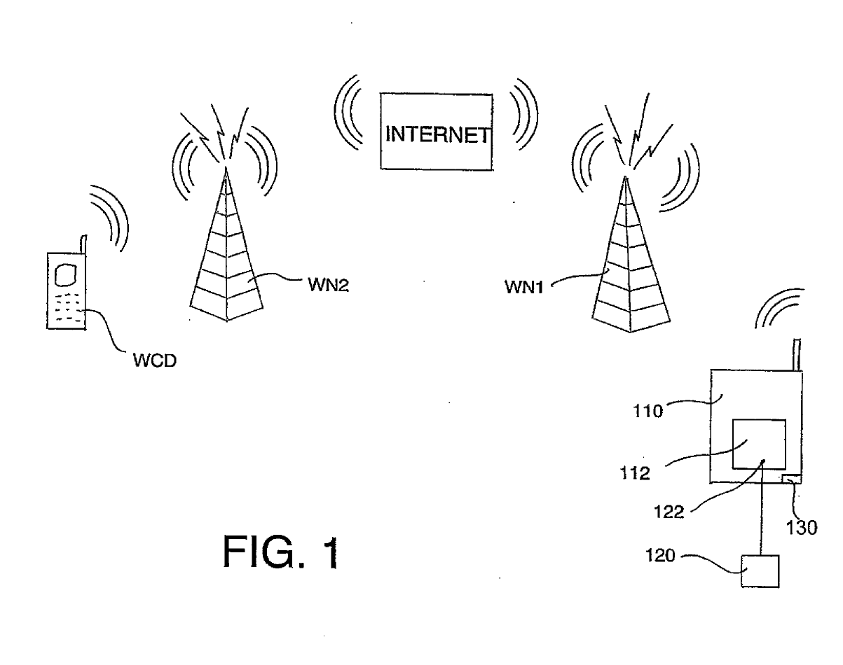

FIG. 1 illustrates a remote monitoring system 100 according to the invention. The remote monitoring system comprises a communicator 110, an event sensor 120, and a power source 130. The event sensor 120 may be any type of sensor that monitors some physical characteristic or condition. Examples of event sensors that may be used with the remote monitoring system 100 include, but are not limited to, sensors for measuring water level, temperature, voltage, salinity, orientation, noise, etc. The output of the event sensor 120 is connected to an input 122 on a printed circuit board 112 in the communicator 110. The power source 130 is ideally a battery and, depending on the particular application of the system, a solar-powered battery or a rechargeable battery pack.

The communicator 110 is a wireless transceiver, capable of transmitting messages to and receiving messages from a wireless communication device WCD via a wireless network WN. The wireless network WN is shown as a cellular technology tower, and the communication device WCD as a cell phone, but this is for illustration purposes only. The wireless network WN may, in fact, be based on any conventional wireless technology, such as, for example, cellular or satellite communication technology, pager communication technology, and/or radio broadcast technology, etc. The communication device WCD may be any device that is capable of receiving communication from the wireless network WN, such as, for example, cell phone, satellite phone, pager, radio receiver, or computer.

An example of the remote monitoring system 100 according to the invention is given below, to illustrate the cooperation between the components of the system. This illustration does not limit the application of the remote monitoring system 100 in any way. The illustrative remote monitoring system 100 is a system for monitoring the water level in the bilge of a boat. The communicator 110 is a commercially available wireless transceiver module SM5100b from Spreadtrum. This module incorporates a baseband chip, RF chipset, Combo Flash and software, providing all the functionalities of full-featured GSM/GPRS terminals (Global System for Mobile communication and General Packet Radio Service). The printed circuit board 112 is incorporated into the communicator 110. An example of a suitable printed circuit board is the Premcell803 from Premgard. The event sensor 120 is a water sensor from Touchsensor called the “sensaswitchultra”. The communication device WCD is a cell phone, such as the Nokia 6030. Depending on the particular application of the remote monitoring system 100, the communicator 110 may incorporate other features. For example, a GPS module may be incorporated into the communicator 100, thereby allowing notification of the vessel owner or operator, in the event the vessel location changes.

The communicator 110 is mounted in a safe and secure location in a boat. The event sensor 120 is mounted in the bilge of the boat, in a location to detect a water level that is to trigger an alarm signal. The output from the event sensor 120 is connected to an input on the communicator 110. Should the water level rise above the desired level, the event sensor 120 triggers the communicator 110 to send an alarm notification to the communication device WCD via the wireless network WN. The alarm notification is transmitted via a first wireless network WN₁ to the Internet and from there via a second wireless network WN₂ to the communication device WCD of the system user. Should the communicator 110 and the communication device WCD of the system user subscribe to wireless service from the same wireless service provider, the communication between communicator 110 and communication device WCD may be transmitted within the wireless service network, without going through the Internet. The system user generally has access to the communication device WCD and receives the incoming text message from the communicator 110. The system user sends a return message to the communicator 110, to acknowledge receipt of the message. The system user may also use the communication device WCD to reprogram parameters in the communicator 110.

In a preferred embodiment of the method according to the invention, the provider of the remote monitoring system 100 is also a wireless network service provider. System users, when acquiring the remote monitoring system 100 would sign up for service with the remote monitoring system provider, who in turn would subscribe to a sufficient amount of transmission capability to ensure service to all system users. In another embodiment of the method, the system user contracts independently with a service provider of his or her choice to obtain wireless service for the remote monitoring system 100.

Depending on the application of the remote monitoring system 100, the communicator 110 may be a hermetically sealed unit that is relatively impervious to harsh outdoor environments or chemical environments. The communicator may be equipped with an internal or an external antenna, depending on the particular application of the remote monitoring system 100 and the antenna requirements.

It is understood that the embodiments described herein are merely illustrative of the present invention. Variations in the construction of the remote monitoring system may be contemplated by one skilled in the art without limiting the intended scope of the invention herein disclosed and as defined by the following claims.

What is claimed is:

1. A remote monitoring system comprising:
a communicator, adapted to transmit and receive messages from a communication device via a wireless network;
an event sensor that is adapted to sense a physical parameter; and
a power source for providing operating power to said communicator;
wherein, when said event sensor senses an occurrence of said physical parameter, said event sensor transmits a signal to said communicator; and
wherein, upon receiving said signal from said event sensor, said communicator transmits an alarm notification to said communication device.

2. The remote monitoring system of claim 1, wherein said event sensor is a water level sensor.

3. The remote monitoring system of claim 1, wherein said event sensor is a temperature sensor.

4. The remote monitoring system of claim 1, wherein said communicator is programmable.

5. The remote monitoring system of claim 1, wherein said wireless network operates on cellular communication technology and said communication device is a cell phone.

6. The remote monitoring system of claim 1, wherein said wireless network operates on satellite communication technology and said communication device is a satellite phone.

7. The remote monitoring system of claim 1, wherein said wireless network operates on pager communication technololgy and said communication device is a pager.

8. The remote monitoring system of claim 1, wherein said communicator further comprises a GPS receiver for receiving geographic location information from a Global Positioning System and said communicator transmits geographic location information when transmitting said alarm notification.

9. A method of remotely monitoring a threshold value of a physical parameter, said method comprising the steps of:
a) outfitting a physical structure with a remote monitoring system that comprises a programmable communicator and an event sensor, said event sensor sending a signal to said communicator when said physical parameter to be monitored deviates from said threshold value; and
b) programming said communicator to transmit an alarm notification to an address of a user via a remote communication network upon receiving said signal from said event sensor.

10. The method of claim 9, wherein said step b) comprises the step of:
b1) programming said communicator to transmit said alarm notification via a first wireless network to an Internet server and from said Internet server via a second wireless communicator to a communication device of said user.

11. The method of claim 9, further comprising the step of
c) programming said communicator to repeatedly resend said alarm notification until an acknowledgement is received from said user.

12. The method of claim 9, further comprising the step of
d) transmitting a message from said user via said remote communication network to said communicator to change said threshold value.

13. The method of claim 9, wherein said physical structure is a marine vessel and said event sensor is a water level sensor, said method comprising the steps of:
e) mounting said event sensor in a bilge of said marine vessel, so as to detect a water level above said threshold value;
f) communicably connecting said event sensor to said communicator;
g) when water level in said bilge rises above said threshold value, transmitting a signal from said event sensor to said communicator,
h) transmitting an alarm notification from said communicator via a wireless technology to said user; and
i) receiving said alarm notification on said communication device of said user.

14. The method of claim 13, further comprising the step of:
j) cessation of transmission of said alarm notification upon receipt of an acknowledgement of receipt of said alarm notification by said user.

15. The method of claim 9, further comprising the steps of:
k) sensing a return-to-normal status of said physical parameter by said event sensor;
l) transmitting a return-to-normal signal from said event sensor to said communicator; and
m) transmitting said return-to-normal signal to said user via said remote communication network.
